(19) United States
(12) Patent Application Publication
(10) Pub. No.: US 2025/0227197 A1
(43) Pub. Date: Jul. 10, 2025

(54) SMART FRAME RATE REDUCTION

(71) Applicant: QUALCOMM Incorporated, San Diego, CA (US)

(72) Inventors: Tony Gogoi, San Diego, CA (US); Praveen Chavan, San Diego, CA (US); Ajit Singh Solanki, San Diego, CA (US)

(21) Appl. No.: 18/408,197

(22) Filed: Jan. 9, 2024

(51) Int. Cl. H04N 7/01; H04N 19/115; H04N 19/167; H04N 19/172

(52) U.S. Cl. CPC H04N 7/013; H04N 19/115; H04N 19/167; H04N 19/172

(57) ABSTRACT

A device and method for encoding are disclosed. The method comprises receiving a sequence of frames and determining an original interframe timestamp spacing based on original timestamps of the frames. In addition, one or more frames are dropped, based upon changes in a region of interest in the sequence of frames, to produce a reduced number of remaining frames. Timestamps of the reduced number of remaining frames are modified so an interframe timestamp spacing of the reduced number of remaining frames is substantially similar to the original interframe timestamp spacing, and the reduced number of remaining frames are encoded before the modified timestamps of the encoded frames are restored to the original timestamps.

### FIELD OF THE DISCLOSURE

The following relates to video processing. In particular, but not by way of limitation, the present invention relates to apparatus and methods for encoding video.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like.

Digital video devices implement video coding techniques, such as those described in the standards defined by MPEG-2, MPEG-4, ITU-T H.263, ITU-T H.264/MPEG-4, Part 10, H.265, Advanced Video Coding (AVC), and other standards presently under development. The video devices may transmit, receive, encode, decode, and/or store digital video information more efficiently by implementing such video coding techniques.

There are many uses of video content that require tremendous amounts of storage, and as a consequence, there is a push for bitrate reduction using a variety of techniques resulting in bitrate reduction rates of two to five times. To reduce frame rates, one standard way is to re-configure the encoder bitrate and framerate dynamically. This presents several challenges. For example, reconfiguration of an encoder involves a convergence time (i.e., a time taken for encoder to adjust to new bitrate) in the video-encoder. So, frequent reconfiguration is not recommended. There is also a risk of video quality fluctuations when framerate/bitrate is modified frequently.

### SUMMARY

One aspect of the present disclosure may be described as a video device comprising a camera system configured to capture a sequence of frames. The video device includes a selective frame encoder configured to receive the sequence of frames, wherein each frame includes an original timestamp and determine, based on changes in a region of interest over the sequence of frames or amount of temporal changes in a sequence of images, a reduced number of remaining frames, wherein the reduced number of remaining frames includes a subset of the sequence of frames. In addition, the selective frame encoder is configured, for each frame of the reduced number of remaining frames, to modify the original timestamp based on an original interframe timestamp spacing of the received sequence of frames to produce a modified timestamp, wherein at least one modified timestamp associated with a particular frame is different than the original timestamp for the particular frame; encode the frame to produce an encoded frame, wherein the encoded frame includes the modified timestamp; and restore the modified timestamp of the encoded frame to the original timestamp; and output the encoded frames.

Another aspect of the disclosure may be described as a method for encoding that includes receiving a sequence of frames, wherein each frame includes an original timestamp; determining an original interframe timestamp spacing based on the original timestamps; and dropping, based on changes in a region of interest in the sequence of frames or amount of temporal changes in a sequence of images, one or more frames in the sequence of frames to produce a reduced number of remaining frames. The method also includes modifying, based on the original interframe timestamp spacing, timestamps of the reduced number of remaining frames so an interframe timestamp spacing of the reduced number of remaining frames is substantially similar to the original interframe timestamp spacing; encoding the reduced number of remaining frames with an encoder; and restoring modified timestamps of the encoded frames to the original timestamps.

Yet another aspect may be characterized as a selective frame encoder that includes frame drop logic configured to receive a sequence of frames and drop, based on changes in a region of interest in the sequence of frames, one or more frames in the sequence of frames to produce a reduced number of remaining frames. In addition, the selective frame encoder includes a timestamp modifier configured to determine an original interframe timestamp spacing based on the original timestamps and modify, based on the original interframe timestamp spacing, timestamps of the reduced number of remaining frames so an interframe timestamp spacing of the reduced number of remaining frames is substantially similar to the original interframe timestamp spacing of the received sequence of frames. The selective frame encoder also includes an encoder configured to encode the reduced number of remaining frames and a timestamp restorer to restore modified timestamps of the encoded frames to the original timestamps.

Another aspect of the disclosure may be described as a non-transitory, computer readable storage medium, encoded with processor readable instructions to perform a method for encoding. The instructions include instructions for receiving a sequence of frames, wherein each frame includes an original timestamp; determining an original interframe timestamp spacing based on the original timestamps; and dropping, based on changes in a region of interest in the sequence of frames or amount of temporal changes in a sequence of images, one or more frames in the sequence of frames to produce a reduced number of remaining frames. The instructions also include instructions for modifying, based on the original interframe timestamp spacing, timestamps of the reduced number of remaining frames so an interframe timestamp spacing of the reduced number of remaining frames is substantially similar to the original interframe timestamp spacing; encoding the reduced number of remaining frames with an encoder; and restoring modified timestamps of the encoded frames to the original timestamps.

### BRIEF DESCRIPTION OF THE DRAWINGS

FIG. 1 is a block diagram depicting an environment of several embodiments.

FIG. 2 is a flowchart depicting a method that may be traversed in connection with several embodiments.

FIG. 3 is an example of processing that may be carried out on a sequence of frames.

FIG. 4 is a block diagram depicting an example of a video system.

FIG. 5 is a block diagram depicting another example of a video system.

FIG. 6 is a block diagram depicting yet another example of a video system.

FIG. 7 is a flow chart depicting another method that may be traversed in connection with several embodiments.

FIG. 8 is a block diagram of a devices that may implement aspects of the present disclosure.

### DETAILED DESCRIPTION

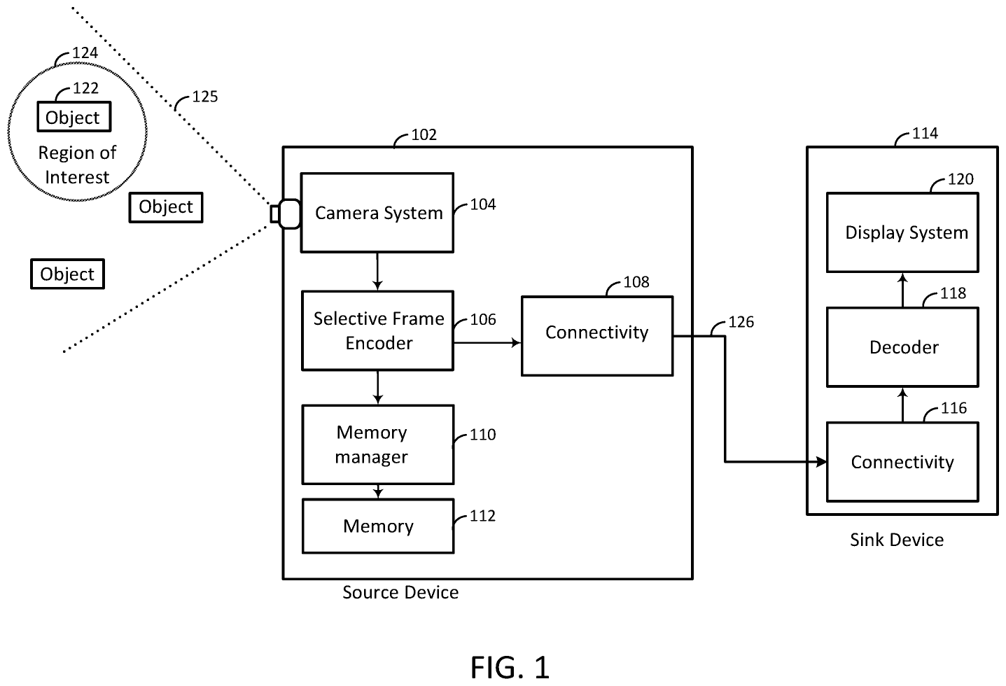

Referring first to FIG. 1, shown is a block diagram depicting an example environment in which embodiments disclosed herein may be implemented. As shown, a source device 102 includes a camera system 104, a selective frame encoder 106, a connectivity module 108, a memory manager 110, and memory 112. The source device 102 generally operates as a video device that is communicatively coupled by network connection 126 to a sink device 114, and the sink device 114 includes a connectivity module 116, a decoder 118, and a display system 120. The network connection 126 may include any collection of devices (e.g., communication devices, computers, servers, mainframes, peripherals, etc.) that facilitate communication and data sharing between the source device 102 and the sink device 114.

In general, the camera system 104 is configured to capture a sequence of frames (e.g., YUV frames) that includes a sequence of images, and the images may include images of one or more objects 122 within a region of interest 124 of a sensing area 125 of the camera system 104. In some implementations, for example and without limitation, the camera system 104 may capture images at 4K resolution and provide a session rate of 30 frames per second (FPS) utilizing H.264 and/or H.265 video capture protocols. But the resolution, FPS, and protocols are only examples, and it is certainly contemplated that a variety of different resolutions, FPS ranges, and protocols may be utilized by the camera system 104. It should be recognized that the region of interest 124 is depicted in FIG. 1 as a portion of the sensing area 125 for the camera system 104 as an example only, but the region of interest 124 may be coextensive with the sensing area 125. For example, the camera system 104 may not be equipped with the functionality to define a region of interest 124 that is less than the sensing area 125, so the region of interest 124 is coextensive with the sensing area 125 by default. It is also contemplated that the region of interest 124 may be configured to be a portion of the sensing area 125 or the entire sensing area 125.

The selective frame encoder 106 generally operates to selectively encode a subset of the sequence of frames to produce a reduced number of encoded frames (resulting in a lower bitrate) and provide the reduced number of encoded frames with timestamps that are substantially the same as the timestamps of corresponding original timestamps.

Rather than requiring reconfiguring an encoder bitrate, which may result in issues in the encoder and/or across the entire media pipeline, frames of the received frame sequence are selectively dropped to achieve a bitrate reduction using frame-rate reduction. And in many variations, image quality (e.g., image detail) does not substantially change when switching between a session FPS/bitrate and a desired lower FPS/bitrate.

An example use case for the system depicted in FIG. 1 is commercial grade surveillance where 24-hour monitoring results in a tremendous number of frames being produced by the camera system 104. In such a use case, the selective frame encoder 106 can substantially reduce the bitrate relative to the bitrate that would be required to encode all of the frames produced by the camera system 104—without pausing and resuming the live-stream from the camera and without reconfiguring encoding parameters that are utilized. As a consequence, problems with convergence time and the risk of video quality fluctuations are avoided.

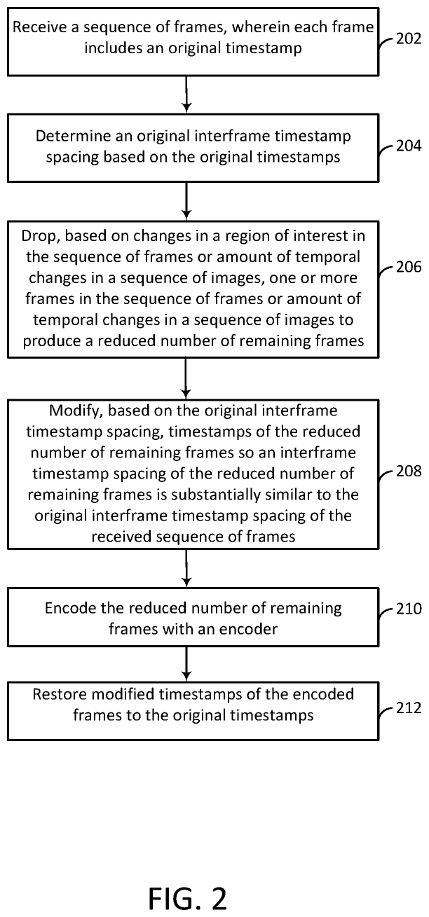

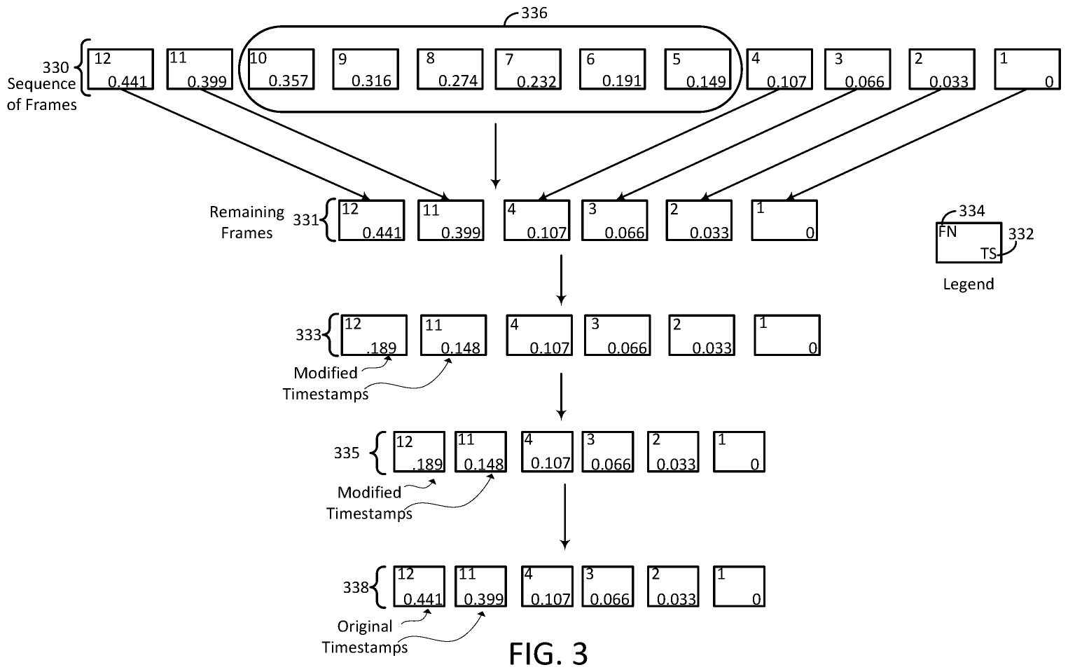

While referring to FIG. 1, simultaneous reference is made to FIG. 2, which is a flow chart depicting a method that may be traversed in connection with many embodiments disclosed herein. In addition, reference is also made to FIG. 3, which depicts an example of how a sequence of frames captured by the camera system 104 may be processed by the selective frame encoder 106. In FIG. 3, a timestamp (TS) 332 and a frame number (FN) 334 are shown to provide references for a specific example. The frame numbers 334 are arbitrarily chosen for this example to help track corresponding frames during processing by the selective frame encoder 106. Similarly, the timestamps 332 are chosen merely as an example of the type of timestamps that may be present in each frame.

Although the timestamps 332 are fabricated for this example, the timestamps 332 do depict a change in the FPS of the sequence of frames 330. As shown, the interframe timestamp spacing between frame 1 and frame 2 is about 33 ms, which is about 30 FPS, and similarly, the interframe timestamp spacing between frame 2 and frame 3 is about 33 ms, so the FPS from frame 1 to frame 3 is about 30 FPS. But the interframe timestamp spacing between frames 3 and 4, between frames 4 and 5, and between frames 5 and 6 is about 41 ms, which is about 24 frames per second. So, FIG. 3 illustrates an example where the FPS of the sequence of frames 330 provided to the selective frame encoder 106 changes from 30 FPS to 24 FPS.

As shown, the selective frame encoder 106 receives a sequence of frames 330 wherein each frame includes an original timestamp 332 (Block 202), and the selective frame encoder 106 determines an original interframe timestamp spacing based on the original timestamps (Block 204). As discussed above, the FPS of the sequence of frames 330 may vary (e.g., because lighting conditions change), so the determination of the original interframe timestamp spacing at Block 204 is helpful when modifying the timestamps as discussed further herein.

In the example depicted in FIG. 3, it is assumed that the camera system 104 provides the sequence of frames 330 at a session FPS of 30 FPS. This means the minimum interframe spacing is 33 ms, which can increase dynamically based on lighting conditions. One approach to determining the original interframe timestamp spacing (at Block 204) is to use the last two received frames. For example, the selective frame encoder 106 may be configured to determine the original interframe timestamp spacing by determining a difference between at least two frames of the received sequence of frames. Assuming, for example, that the last two received frames in FIG. 3 are frames 3 and 4, the original interframe timestamp spacing is 41 ms. Another approach to determining the original interframe timestamp spacing (at Block 204) is to take a modal value of the spacing between a selected number (e.g., four) of the received frames. Assuming the last four frames are frames 1-4, the interframe timestamp spacing is 33 ms, 33 ms, and 41 ms and the modal value f (33, 33, 41)=33 ms. It should be recognized that the number of frames need not be four frames. It is also contemplated that other statistical functions (e.g., the average function) may be used to arrive at a numerical representation of interframe timestamp spacing.

As shown in FIG. 2, based upon changes in the region of interest 124 in the sequence of frames 330 or amount of temporal changes in a sequence of images, one or more frames in the sequence of frames 330 are dropped to produce a reduced number of remaining frames 331 (Block 206). The number of frames that are dropped (at Block 206) may be based upon a desired, lower FPS that is established using a set of changed-based thresholds that are compared against an amount of change across the sequence of frames 330 in the region of interest 124. As one of ordinary skill in the art appreciates, a change value may be used to characterize the amount of change that occurs in the sequence of frames 330, and when the change value reaches a threshold, the threshold is mapped to a desired FPS. It is also contemplated that the desired FPS may be calculated using a continuous function that provides a desired FPS based upon a change value. A suitable set of FPS values ensures that the frames to be encoded across the dropped frames have temporal changes within suitable bounds. And determining an interframe spacing (at Block 204) that is close to the observed input interframe buffer timestamp delta “tricks” the encoder into being unaware of an FPS drop while still capturing the dynamic lighting conditions. This technique allows a variable FPS encoder to be agnostic of the configured bitrate. In other words, the encoder may be configured to maintain an encoder configuration regardless of the changes in the region of interest in the sequence of frames.

As shown in FIG. 3, an example of dropped frames 336 are depicted as frames 5 through 10, and after the dropped frames 336 are released, the reduced number of remaining frames 331 (a subset of the sequence of frames) persist. As shown in the example of FIG. 3, frames 1-4 and frames 11-12 remain.

As depicted in FIG. 2, timestamps of the reduced number of remaining frames 331 are modified so an interframe timestamp spacing of the reduced number of remaining frames 331 is substantially similar to the original interframe timestamp spacing of the received sequence of frames (Block 208). As shown in FIG. 3, at least one modified timestamp associated with a particular frame is different than the original timestamp for the particular frame. For example, after modification, the timestamp of frame 11 is 0.148, which is different than the original timestamp for frame 11, which was 0.399.

In the example depicted in FIG. 3, before the modification of timestamps (at Block 208) there is a substantial 292 ms jump between the timestamps of frame 4 and frame 11 in the reduced number of remaining frames 331. Without modification, the FPS of the remaining frames 331 would appear to be about 3.4 FPS. But modification of the timestamps of frames 11 and 12 results in modified timestamps that indicate the FPS of the remaining frames with modified timestamps 333 is about 24FPS for frames 4, 11, and 12, which is substantially similar to the FPS that frames 4-12 (of the sequence of frames 330) would have presented to the encoder. By modifying the timestamps (at Block 208), the actual encoding is completely agnostic of the lowered FPS and the encoder sees frames at an original configured FPS even though frames are being dropped to achieve very low FPS. Also, there is no need to reconfigure the media-pipeline with the new FPS, which is a benefit with frequent FPS changes. This technique also increases a group of pictures (GOP) length in terms of time, which is another benefit.

As shown in FIG. 2, the reduced number of remaining frames are then encoded (Block 210) to produce encoded frames 335 with modified timestamps. It should be recognized that the timestamp modification (at Block 208) causes the encoder to see a compressed/shorter timeline that continuously deviates from the real timeline. More specifically, when the appropriate FPS thresholds are reached (resulting in the dropping of frames at Block 206), the input frames for the encoder are spread across a larger actual time than the encoder is aware of (due to the modification the input timestamps). This results in the encoder spreading a configured bit-budget across a larger actual time resulting in bitrate reduction without reconfiguration. In other words, the encoding (at Block 210) may include encoding the reduced number of remaining frames with a bit-budget that is based upon a framerate of the sequence of frames 330. And quality degradation is negligible because the dynamically chosen FPS is based on a degree of temporal changes.

But for accurate presentation downstream, the modified timestamps need to be restored, so the modified timestamps of the encoded frames 335 are then restored to the original timestamps (Block 212) to produce output frames 338. After the modified timestamps of the encoded frames 335 are restored to the original timestamps (at Block 212), the output frames 338 may be output (e.g., transmitted) to the sink device 114 and/or stored in memory 112.

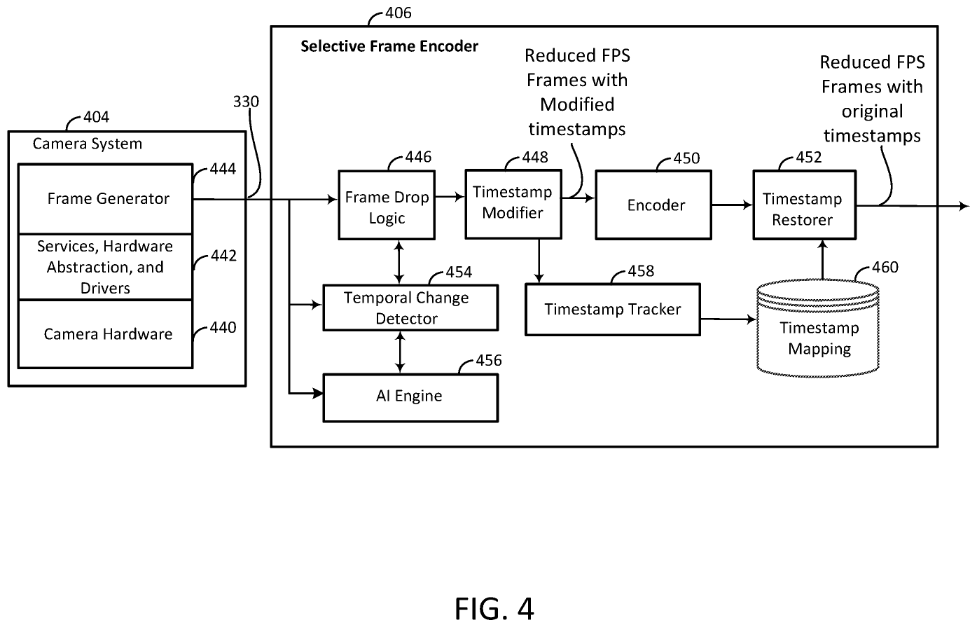

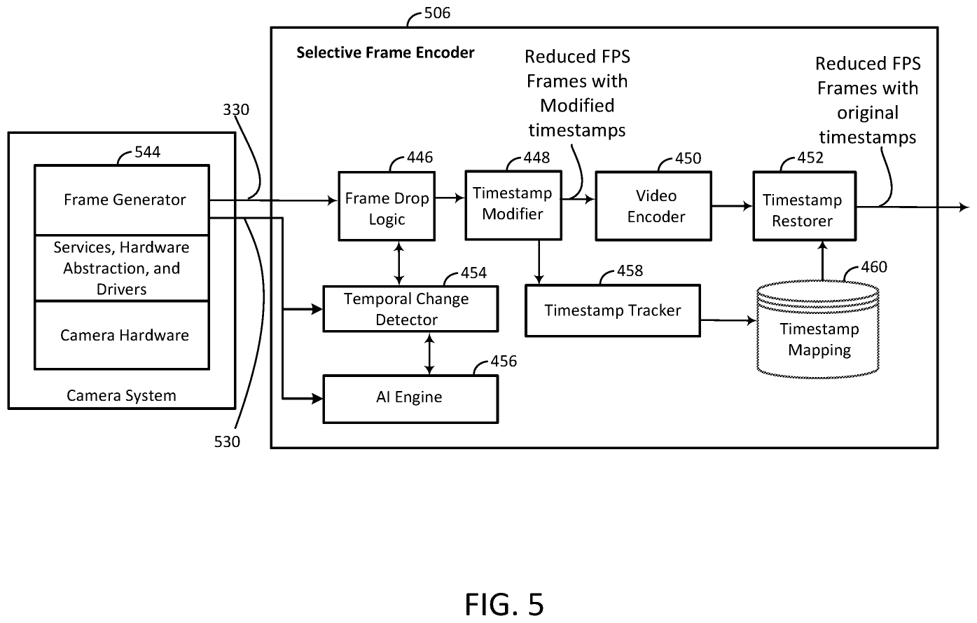

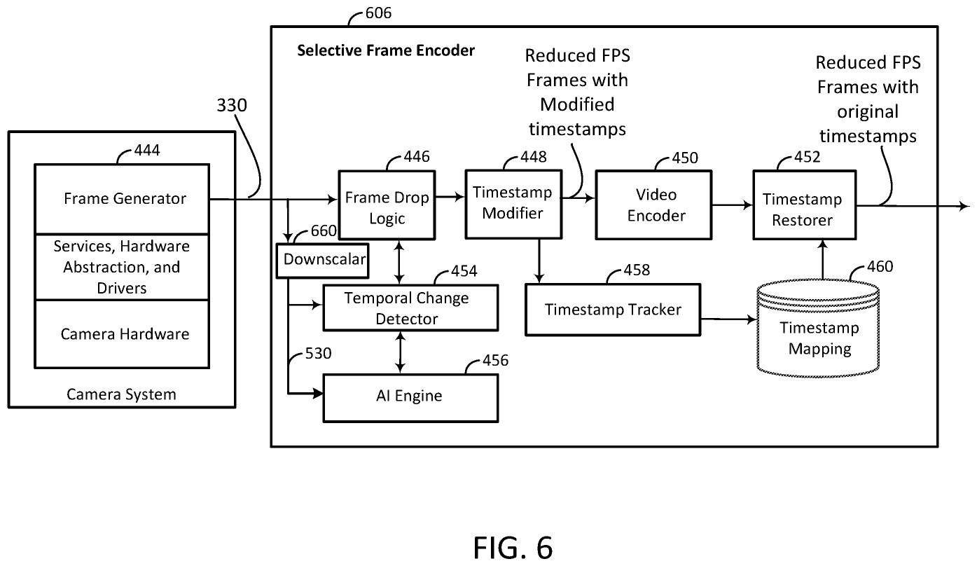

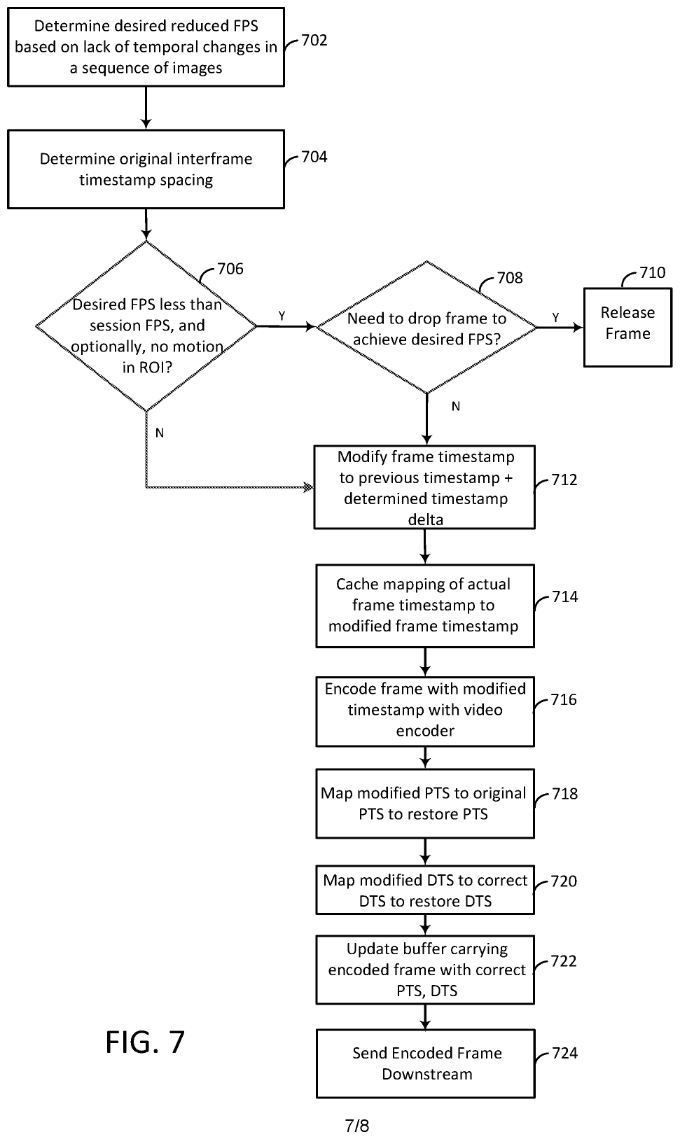

Referring next to FIGS. 4, 5, and 6, shown are block diagrams depicting variations of the camera system 104 and the selective frame encoder 106. Additional details of the interoperation of the subcomponents of these embodiments is provided with reference to a method described in connection with FIG. 7. In the embodiment of FIG. 4, the original, unscaled, sequence of frames 330 is utilized to detect changes in the region of interest 124. In contrast, in the embodiments of FIGS. 5 and 6, scaled and/or a lower FPS of the sequence of frames 330 is utilized to detect changes in the region of interest 124.

Referring first to FIG. 4, shown is a block diagram depicting a video system that may be implemented in the source device 102 to realize the camera system 104 and selective frame encoder 106. It should be recognized, however, that the camera system 404 and the selective frame encoder 406 may, or may not, reside within a common housing. As shown, the camera system 404 includes camera hardware 440, services/hardware abstraction/drivers 442 and a frame generator 444, which are well known to those of ordinary skill in the art to produce the sequence of frames 330, which are provided to the selective frame encoder 406. As discussed above, and as is well known to those of ordinary skill in the art, the camera system 404 may provide the sequence of frames 330 at a dynamic number of frames per second (FPS). For example, the camera system 404 may nominally provide the sequence of frames 330 at 30 FPS, but the camera system 404 may vary the FPS due to a variety of factors including the amount of light that the camera system 404 is exposed to.

As shown, the selective frame encoder 406 in this example includes frame drop logic 446, a timestamp modifier 448, an encoder 450, and a timestamp restorer 452. A temporal change detector 454 is in communication with both the frame drop logic 446 and an artificial intelligence (AI) engine 456. In this variation of the selective frame encoder 406, each of the frame drop logic 446, the temporal change detector 454, and the AI engine 456 are positioned to receive the sequence of frames 330. As shown, a timestamp tracker 458 is in communication with the timestamp modifier 448 and a timestamp mapping cache 460, and the timestamp mapping cache 460 is in communication with the timestamp restorer 452.

In general, the frame drop logic 446 is configured to receive the sequence of frames 330 (where each frame includes an original timestamp) and drop, based on changes in the region of interest 124 in the sequence of frames 330, one or more frames in the sequence of frames to produce the reduced number of remaining frames.

The timestamp modifier 448 is configured to determine an original interframe timestamp spacing based on the original timestamps and modify, based on the original interframe timestamp spacing, timestamps of the reduced number of remaining frames 331 so an interframe timestamp spacing of the reduced number of remaining frames (with modified timestamps) 333 is substantially similar to the original interframe timestamp spacing of the received sequence of frames 330.

The encoder 450 is configured to encode the reduced number of remaining frames, and the timestamp restorer 452 is configured to restore modified timestamps of the encoded frames to the original timestamps to produce the output frames 338.

In general, the temporal change detector 454 is configured characterize a level of changes in the region of interest 124 over the sequence of frames 330. Optical-flow techniques known to those of ordinary skill in the art may be used to characterize a level of changes in the region of interest. In some variations, the frame drop logic 446 is configured to determine the reduced number of remaining frames 331 based upon the level of changes reaching one or more thresholds. For example, multiple thresholds may be established that are configurable where each threshold corresponds to a number of frames per second. One threshold for a high-level of motion, for example, may prompt the frame drop logic 446 to maintain all of the sequence of frames 330. Another threshold for a very low level of motion may prompt the frame drop logic 446 to drop a very high percentage of frames (e.g., 90% of frames). Yet another threshold corresponding to a moderate amount of motion may prompt the frame drop logic 446 to drop 50% of the sequence of frames 330.

Table 1 below provides other specific examples of thresholds that may be used (established in terms of a percentage of temporal changes in an image sequence) and corresponding examples of a reduced number of remaining frames (established in terms of frames per second).

TABLE 1

| Threshold (% of | Reduced Number of |
|---|---|
| temporal changes in | Remaining Frames |
| image sequence) | (FPS) |
| >10% | 30 |
| 6% to 10% | 15 |
| 3% to 6% | 7.5 |
| 0% to 3% | 3.75 |

In other variations, the frame drop logic 446 is configured to determine the reduced number of remaining frames with a function that relates the level of changes to the reduced number of remaining frames. For example, an equation may be used that prompts the frame drop logic 446 to drop a number of frames in inverse relation to the level of changes.

As shown, the AI engine 456 may be used to effectuate machine learning algorithms that enable the temporal change detector 454 to provide a more useful characterization of the level of motion in the region of interest 124. For example, ongoing training may be employed to provide a collection of encoded frames that approach an optimum bitrate for the motion in the region of interest.

The timestamp tracker 458 is configured to cache, in the timestamp mapping cache 460, a mapping of original timestamps of the remaining frames to the modified timestamps to enable the timestamp restorer to restore the modified timestamps of the encoded frames to the original timestamps.

Referring to FIG. 5, in contrast to the frame generator 444 of FIG. 4, the frame generator 544 of FIG. 5 is configured to provide (in addition to the sequence of frames 330) an adjusted sequence of frames 530 at an adjusted resolution and/or an adjusted FPS. As shown, the adjusted sequence of frames 530 is received by the temporal change detector 454 and the AI engine 456 and used by the temporal change detector 454 and the AI engine 456 to enable the characterization of the level of changes in the region of interest to be performed with fewer processing resources. As an example, while the sequence of frames 330 may be streamed at 1080 P and at 30 FPS, the adjusted sequence of frames 530 may be a streamed at a lower resolution (e.g., of 480 P) and at a lower rate (e.g., of 15 FPS). Alternatively, the adjusted sequence of frames 530 may be a streamed at a lower resolution (e.g., of 480 P) and at the original streaming rate (e.g., of 30 FPS). In yet another alternative, the adjusted sequence of frames 530 may be streamed at the same resolution as the sequence of frames 330 (e.g., at 1080 P) and at a lower rate (e.g., of 15 FPS). Aside from the less resource intensive operation of the change characterization, the selective frame encoder 506 of FIG. 5 operates in the same way as the selective frame encoder 406 of FIG. 4.

Referring to FIG. 6, shown is a selective frame encoder 606 that includes a downscaler module 660. As shown the downscaler module 660 is positioned to receive the sequence of frames 330 and is configured to provide the adjusted sequence of frames 530 to the temporal change detector 454 and the AI engine 456. In this embodiment, the downscaler module 660 generates the adjusted sequence of frames 530 instead of the frame generator 544, and the adjusted sequence of frames 530 may have a lower resolution and/or a lower streaming rate than the sequence of frames 330 as described above with reference to FIG. 5. Techniques for downscaling and reducing a number of frames to produce the adjusted sequence of frames 530 are well known, and as a consequence, are not detailed herein.

Referring to FIG. 7, shown is a flowchart depicting another method that may be traversed in connection with the embodiments disclosed herein. As shown, a desired reduced number of frames per second is determined based on a lack of temporal changes in the sequence of frames 330 (Block 702). The frame drop logic 446 may perform this determination by characterizing a level of the changes in the region of interest 124 over the sequence of frames 330 and determining the reduced FPS as discussed above with reference to FIG. 2. In addition, an original interframe timestamp spacing is determined (Block 704). Which may be determined as discussed above with reference to FIG. 2.

As shown, for each frame in a sequence, if the desired FPS is less than a session FPS, and optionally, there is no motion in the region of interest (ROI) 124, (Block 706) and the frame needs to be dropped to achieve the desired FPS (Block 708), then the frame is released (Block 710). But if the desired FPS is less than a session FPS, and optionally, there is no motion in the region of interest (ROI) 124, (Block 706) and the frame does not need to be dropped to achieve the desired FPS (Block 708), then the frame timestamp is modified to be a previous timestamp plus a determined timestamp delta (Block 712). The timestamp tracker 458 then caches a mapping of an actual, original, frame timestamp to the modified timestamp (Block 714). Utilizing motion in the ROI (at Block 706) is an optional aspect that may or may not be used depending upon whether data is available (e.g., from an AI engine) about motion in the ROI.

As shown, the frame (with the modified timestamp) is then encoded with the encoder 450 to produce an encoded frame that includes the modified timestamp (Block 716). Those of ordinary skill in the art will appreciate, in view of this disclosure, that the encoded frame may include a presentation timestamp (PTS) and a decoding timestamp (DTS), and that both the resultant PTS and DTS will need to be restored to the original PTS and DTS. As a consequence, the timestamp restorer 452 accesses the timestamp mapping cache 460 to follow the cached mapping between the modified PTS timestamp and the original PTS timestamp (Block 718) and the timestamp restorer 452 accesses the timestamp mapping cache 460 to follow the cached mapping between the modified DTS and the correct DTS (Block 720). The mapping enables the original PTS and correct DTS to be obtained to enable the timestamp restorer 452 to update the buffer carrying the encoded frame with the original PTS and correct DTS (Block 722). The encoded frame (with the restored PTS and DTS timestamps) is then sent downstream (e.g., to the memory manager 110 (so memory manager 110 may direct the encoded frame to memory 112) and/or to the connectivity module 108) (Block 724).

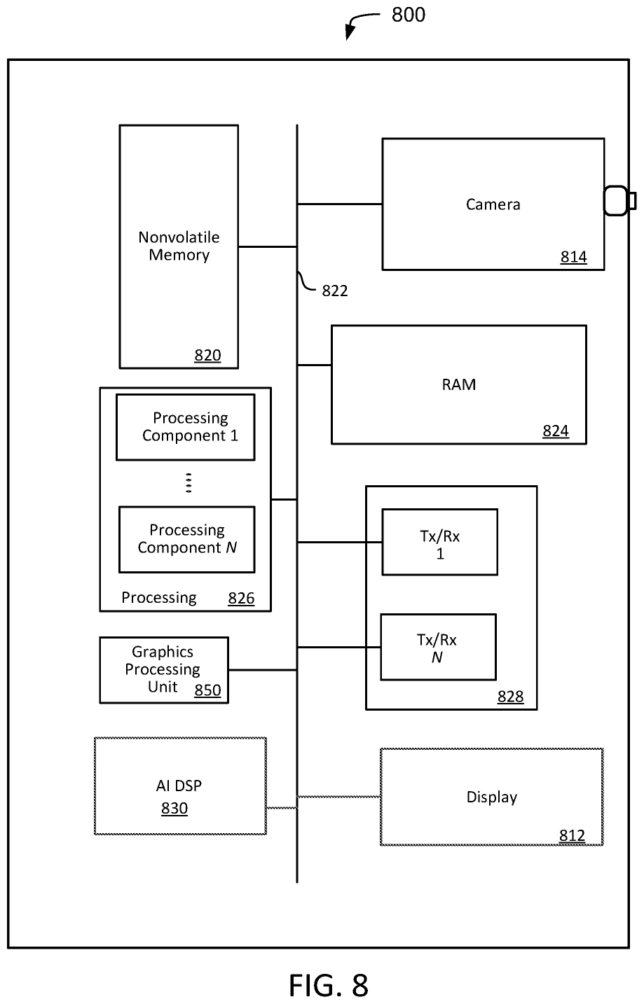

Referring next to FIG. 8, shown is a block diagram depicting physical components of an exemplary device 800 that may be utilized to realize the source device 102 and/or the sink device 114. As shown, the device 800 may include a camera 814, display portion 812, and nonvolatile memory 820 that are coupled to a bus 822 that is also coupled to random access memory (“RAM”) 824, a processing portion (which includes N processing components) 826, a transceiver component 828 that includes N transceivers, and a graphics processing component 850. Although the components depicted in FIG. 8 represent physical components, FIG. 8 is not intended to be a detailed hardware diagram; thus, many of the components depicted in FIG. 8 may be realized by common constructs or distributed among additional physical components. Moreover, it is certainly contemplated that other existing and yet-to-be developed physical components and architectures may be utilized to implement the functional components described with reference to FIG. 8.

This display portion 812 generally operates to provide a presentation of content to a user. In several implementations, the display is realized by an LCD or OLED display. In general, the nonvolatile memory 820 is a non-transitory processor readable medium to store (e.g., persistently store) data and instructions encoded in executable code including code that is associated with the functional components described herein. In some embodiments for example, the nonvolatile memory 820 includes bootloader code, modem software, operating system code, file system code, and code to facilitate the implementation of one or more portions of the selective frame encoder 106.

In many implementations, the nonvolatile memory 820 is realized by flash memory (e.g., NAND or ONENAND™ memory), but it is certainly contemplated that other memory types may be utilized as well. Although it may be possible to execute the code from the nonvolatile memory 820, the executable code in the nonvolatile memory 820 is typically loaded into RAM 824 and executed by one or more of the N processing components in the processing portion 826. In many embodiments, the memory 112 and the timestamp mapping cache 460 may be implemented through the nonvolatile memory 820, the RAM 824, or some combination thereof.

The N processing components in connection with RAM 824 generally operate to execute the instructions stored in nonvolatile memory 820 to effectuate the functional components described herein. As one of ordinarily skill in the art will appreciate, the processing portion 826 may include a video processor, modem processor, DSP, and other processing components. The graphics processing unit (GPU) 850 depicted in FIG. 8 may be used to realize the graphics processing unit functions described herein. For example, the GPU 850 may be used to implement the encoder 450.

The depicted transceiver component 828 includes N transceiver chains, which may be used to realize the connectivity module 108 and or the connectivity module 116. Each of the N transceiver chains may represent a transceiver associated with a particular communication scheme. Also shown is an artificial intelligence (AI) digital signal processor (DSP) 830 that may be used to realize the AI engine 456 described with reference to FIGS. 4, 5, and 6.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A video device comprising:
a camera system configured to capture a sequence of frames;
a selective frame encoder configured to:
receive the sequence of frames, wherein each frame includes an original timestamp;
determine, based on changes in a region of interest over the sequence of frames, a reduced number of remaining frames, wherein the reduced number of remaining frames includes a subset of the sequence of frames;
for each frame of the reduced number of remaining frames:
modify the original timestamp based on an original interframe timestamp spacing of the received sequence of frames to produce a modified timestamp, wherein at least one modified timestamp associated with a particular frame is different than the original timestamp for the particular frame;
encode the frame to produce an encoded frame, wherein the encoded frame includes the modified timestamp; and
restore the modified timestamp of the encoded frame to the original timestamp; and
output the encoded frames.

2. The video device of claim 1, wherein the selective frame encoder is configured to:
characterize a level of the changes in the region of interest over the sequence of frames; and
determine the reduced number of remaining frames based upon the level of changes reaching one or more thresholds.

3. The video device of claim 1, wherein the selective frame encoder is configured to:
characterize a level of the changes in the region of interest over the sequence of frames; and
determine the reduced number of remaining frames with a continuous function that relates the level of changes to the reduced number of remaining frames.

4. The video device of claim 1 wherein the selective frame encoder is configured to:
to modify original timestamps of the reduced number of remaining frames so an interframe timestamp spacing of the reduced number of remaining frames is substantially similar to the original interframe timestamp spacing.

5. The video device of claim 1, wherein the selective frame encoder is configured to determine the original interframe timestamp spacing by determining a modal value of a selected number of the received sequence of frames.

6. The video device of claim 1, wherein the selective frame encoder is configured to determine the original interframe timestamp spacing by determining a difference between at least two frames of the received sequence of frames.

7. The video device of claim 1 wherein the selective frame encoder is configured to:
cache a mapping of original timestamps of the reduced number of remaining frames to the modified timestamps to enable the modified timestamps of the encoded frames to be restored to the original timestamps.

8. The video device of claim 1, comprising:
memory; and
a memory manager to receive the encoded frames and direct the encoded frames to the memory.

9. The video device of claim 1, comprising:
a connectivity module to transmit the encoded frames.

10. A method for encoding comprising:
receiving a sequence of frames, wherein each frame includes an original timestamp;
determining an original interframe timestamp spacing based on the original timestamps;
dropping, based on changes in a region of interest in the sequence of frames, one or more frames in the sequence of frames to produce a reduced number of remaining frames;
modifying, based on the original interframe timestamp spacing, timestamps of the reduced number of remaining frames so an interframe timestamp spacing of the reduced number of remaining frames is substantially similar to the original interframe timestamp spacing;
encoding the reduced number of remaining frames with an encoder; and
restoring modified timestamps of the encoded frames to the original timestamps.

11. The method of claim 10, comprising:
characterizing a level of the changes in the region of interest over the sequence of frames; and
dropping the one or more frames based upon the level of changes reaching one or more thresholds.

12. The method of claim 10, comprising:
characterizing a level of the changes in the region of interest over the sequence of frames; and
dropping the one or more frames based upon a continuous function that relates the level of changes to the reduced number of remaining frames.

13. The method of claim 10, wherein the encoding includes encoding the reduced number of remaining frames with a bit-budget that is based upon a framerate of the received sequence of frames.

14. The method of claim 10, comprising:
determining the original interframe timestamp spacing by determining a modal value of a selected number of the sequence of frames.

15. The method of claim 10, comprising:
determining the original interframe timestamp spacing by determining a difference between two frames of the sequence of frames.

16. The method of claim 10 comprising:
caching a mapping of original timestamps of the reduced number of remaining frames to the modified timestamps to enable the modified timestamps of the encoded frames to be restored to the original timestamps.

17. The method of claim 10, comprising:
storing the encoded frames in memory.

18. The method of claim 10, comprising:
transmitting the encoded frames.

19. The method of claim 10 comprising:
maintaining an encoder configuration of the encoder regardless of the changes in the region of interest in the sequence of frames.

20. A selective frame encoder comprising:
frame drop logic configured to:
receive a sequence of frames, wherein each frame includes an original timestamp;
drop, based on changes in a region of interest in the sequence of frames, one or more frames in the sequence of frames to produce a reduced number of remaining frames;
a timestamp modifier configured to:
determine an original interframe timestamp spacing based on the original timestamps; and
modify, based on the original interframe timestamp spacing, timestamps of the reduced number of remaining frames so an interframe timestamp spacing of the reduced number of remaining frames is substantially similar to the original interframe timestamp spacing of the received sequence of frames;
an encoder configured to encode the reduced number of remaining frames; and
a timestamp restorer to restore modified timestamps of the encoded frames to the original timestamps.

21. The selective frame encoder of claim 20 comprising a temporal change detector configured to:
characterize a level of changes in the region of interest over the sequence of frames.

22. The selective frame encoder of claim 21, wherein the frame drop logic is configured to:
determine the reduced number of remaining frames based upon the level of changes reaching one or more thresholds.

23. The selective frame encoder of claim 21, wherein the frame drop logic is configured to:
determine the reduced number of remaining frames with a continuous function that relates the level of changes to the reduced number of remaining frames.

24. The selective frame encoder of claim 20, wherein the encoder is configured to maintain an encoder configuration regardless of the changes in the region of interest in the sequence of frames.

25. The selective frame encoder of claim 24, wherein the timestamp modifier is configured to determine the original interframe timestamp spacing by determining a modal value of a selected number of the received sequence of frames.

26. The selective frame encoder of claim 24, wherein the timestamp modifier is configured to determine the original interframe timestamp spacing by determining a difference between two frames of the received sequence of frames.

27. The selective frame encoder of claim 20 wherein the selective frame encoder comprises a timestamp tracker configured to cache a mapping of original timestamps of the remaining frames to the modified timestamps to enable the modified timestamps of the encoded frames to be restored to the original timestamps.

28. The selective frame encoder of claim 20, comprising:
memory; and
a memory manager to receive the encoded frames and direct the encoded frames to the memory.

29. The selective frame encoder of claim 20, comprising:
a connectivity module to transmit the encoded frames.

30. A non-transitory processor readable medium encoded with instructions for encoding, the instructions comprising instructions to:
receive a sequence of frames, wherein each frame includes an original timestamp;
determine an original interframe timestamp spacing based on the original timestamps;
drop, based on changes in a region of interest in the sequence of frames, one or more frames in the sequence of frames to produce a reduced number of remaining frames;
modify, based on the original interframe timestamp spacing, timestamps of the reduced number of remaining frames so an interframe timestamp spacing of the reduced number of remaining frames is substantially similar to the original interframe timestamp spacing of the received sequence of frames;
encode the reduced number of remaining frames with an encoder; and
restore modified timestamps of the encoded frames to the original timestamps.

31. The non-transitory processor readable medium of claim 30, comprising:
characterizing a level of the changes in the region of interest over the sequence of frames; and
dropping the one or more frames based upon the level of changes reaching one or more thresholds.

32. The non-transitory processor readable medium of claim 30, comprising:
characterizing a level of the changes in the region of interest over the sequence of frames; and
dropping the one or more frames based upon a continuous function that relates the level of changes to the reduced number of remaining frames.

33. The non-transitory processor readable medium of claim 30, wherein the encoding includes encoding the reduced number of remaining frames with a bit-budget that is based upon a framerate of the received sequence of frames.

34. The non-transitory processor readable medium of claim 30, comprising:
determining the original interframe timestamp spacing by determining a modal value of a selected number of the sequence of frames.

35. The non-transitory processor readable medium of claim 30, comprising:
determining the original interframe timestamp spacing by determining a difference between two frames of the sequence of frames.

36. The non-transitory processor readable medium of claim 30 comprising:
caching a mapping of original timestamps of the reduced number of remaining frames to the modified timestamps to enable the modified timestamps of the encoded frames to be restored to the original timestamps.

37. The non-transitory processor readable medium of claim 30, comprising:
storing the encoded frames in memory.

38. The non-transitory processor readable medium of claim 30, comprising:
transmitting the encoded frames.

39. The non-transitory processor readable medium of claim 30 comprising:
maintaining an encoder configuration of the encoder regardless of the changes in the region of interest in the sequence of frames.
